(19) United States
(12) Patent Application Publication
(10) Pub. No.: US 2026/0210241 A1
(43) Pub. Date: Jul. 23, 2026

(54) MULTI-CHANNEL ACOUSTIC RECEIVER FOR ACOUSTIC COMMUNICATION NETWORK

(71) Applicant: SCHLUMBERGER TECHNOLOGY CORPORATION, Sugar Land, TX (US)

(72) Inventors: Yann DUFOUR, Rosharon, TX (US); Fernando GARCIA-OSUNA, KATY, TX (US); Arnaud CROUX, Clamart (FR); Arnaud JARROT, Clamart (FR); Benoit DEVILLE, Houston, TX (US); Gloria CHOI, Cambridge, MA (US)

(21) Appl. No.: 19/136,304

(22) PCT Filed: Dec. 12, 2023
(86) PCT No.: PCT/US2023/083508

§ 371 Date: Jun. 6, 2025

Related U.S. Application Data
(60) Provisional application No. 63/386,927, filed on Dec. 12, 2022.

(51) Int. Cl. E21B 47/16; G01V 1/22; G01V 1/46

(52) U.S. Cl. CPC E21B 47/16; G01V 1/22; G01V 1/46; E21B 2200/22

(57) ABSTRACT

A wireless communications system includes a network of acoustic modems for communicating messages between downhole equipment and a surface control and telemetry system. The acoustic modems include multi-channel acoustic receivers that are uniquely deployed along an acoustic transmission medium to provide spatial diversity. Acoustic signals received on the multiple receiver channels are combined and filtered using a Bayesian-type filter to reduce noise.

### CROSS REFERENCE TO RELATED APPLICATIONS

This application claims the benefit of U.S. Provisional Patent Application No. 63/386,927 filed Dec. 12, 2022, the entire contents of which are hereby incorporated in their entirety.

### BACKGROUND

Hydrocarbon fluids such as oil and natural gas are obtained from a subterranean geologic formation, referred to as a reservoir, by drilling a well that penetrates the hydrocarbon-bearing formation. Once a wellbore is drilled, various forms of well completion components may be installed to control and enhance the efficiency of producing the various fluids from the reservoir. Data representative of various downhole parameters, such as downhole pressure and temperature, are often monitored and communicated to the surface during operations before, during and after completion of the well, such as during drilling, perforating, fracturing, and well testing operations. In addition, control information often is communicated from the surface to various downhole components to enable, control, or modify the downhole operations.

Accurate and reliable communications between the surface and downhole components during operations can be difficult. Wired communication systems can be used in which electrical or optical signals are transmitted via a cable. However, the cable used to transmit the communications generally requires complex connections at pipe joints and to traverse certain downhole components, such as packers. In addition, the use of a wireline tool is an invasive technique which can interrupt productions or affect other operations being performed in the wellbore. Thus, wireless communication systems can be used to overcome these issues.

An example of a wireless system is an acoustic communication system. In acoustic systems, information or messages are exchanged between downhole components and surface systems using acoustic transmission mediums. As an example, a network of acoustic devices can be deployed downhole that uses tubing in the wellbore as the medium for transmitting information acoustically.

### SUMMARY

Certain embodiments of the present disclosure are directed to a method of communicating in an acoustic communication system that includes a plurality of acoustic modems that exchange messages on an acoustic communications medium deployed in a borehole. The method includes transmitting, by a first acoustic modem, an acoustic signal to transmit a message on the acoustic communication medium deployed in the borehole. The method also includes receiving, by a second acoustic modem, the acoustic signal on a plurality of receiver channels, wherein each receiver channel comprises an acoustic sensor, and wherein the plurality of receiver channels are deployed with unique orientations and/or at unique locations along the acoustic communications medium in a manner that provides spatial diversity. The acoustic signals received on the plurality of receiver channels are filtered and combined to reduce noise, to thereby reconstruct the message.

Further embodiments of the present disclosure are directed to a system for performing a downhole operation in a wellbore. The system includes a control and telemetry system to control and monitor a downhole operation, downhole equipment located in the wellbore to observe a parameter of interest associated with the downhole operation, and first and second acoustic modems coupled to an acoustic transmission medium at respective locations extending between the control and telemetry system and the downhole equipment. The first acoustic modem transmits an acoustic signal carrying telemetry information from the downhole equipment, and the second acoustic modem receives the acoustic signal on a plurality of receiver channels. Each receiver channel comprises an acoustic sensor deployed at a unique physical location and/or with a unique orientation along the acoustic transmission medium. The first modem and the second modem may comprise a transceiver.

### BRIEF DESCRIPTION OF THE DRAWINGS

Certain embodiments of the invention are described with reference to the accompanying drawings, wherein like reference numerals denote like elements. It should be understood, however, that the accompanying drawings illustrate the various implementations described herein and are not meant to limit the scope of various technologies described herein. The drawings show and describe various embodiments of the current invention.

FIG. 1 is a schematic illustration of a downhole wireless communications system, in accordance with an embodiment.

FIG. 2 is a schematic illustration of an acoustic modem that can be deployed in a downhole wireless communications system, in accordance with an embodiment.

FIG. 3 is a schematic illustration of message communication in a downhole wireless communications system having single channel receivers.

FIG. 4 is a schematic illustration of message communication in a I downhole wireless communications system having multi-channel receivers, in accordance with an embodiment.

FIG. 5 is an example of an approach implemented by a multi-channel wireless modem for combining multiple channels in a multi-channel downhole wireless communications system, in accordance with an embodiment.

FIG. 6 illustrates the performance improvement relative to a single channel wireless modem that can be obtained using a multi-channel wireless modem, in accordance with an embodiment.

FIG. 7 a perspective view of an example of a multi-channel wireless modem 102 connected to tubing deployed in a wellbore, in accordance with an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

In the specification and appended claims: the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”, “upper” and “lower”, “upwardly” and downwardly”, “upstream” and “downstream”; “above” and “below”; and other like terms indicating relative positions above or below a given point or element are used in this description to more clearly describe some embodiments of the invention.

Wireless communication networks can be used to transmit information or messages between, for instance, a control and telemetry system and various tools or other devices. When a wireless communication network is used in a hydrocarbon exploration, testing or production environment, the control and telemetry system typically is located at the surface and the tools or other devices are located downhole in a wellbore. The tools and devices are referred to as downhole equipment and can include, for example, packers, valves, chokes, firing heads, perforators, samplers, pressure gauges, temperature sensors, flow meters, and fluid analyzers. Messages exchanged between the surface system and the downhole equipment can be used to operate the equipment (e.g., a valve or a firing head), to control the performance of a downhole operation, or to monitor various downhole conditions before, during or after an operation, such as fluid flow, tool status, temperature, pressure, and fluid composition.

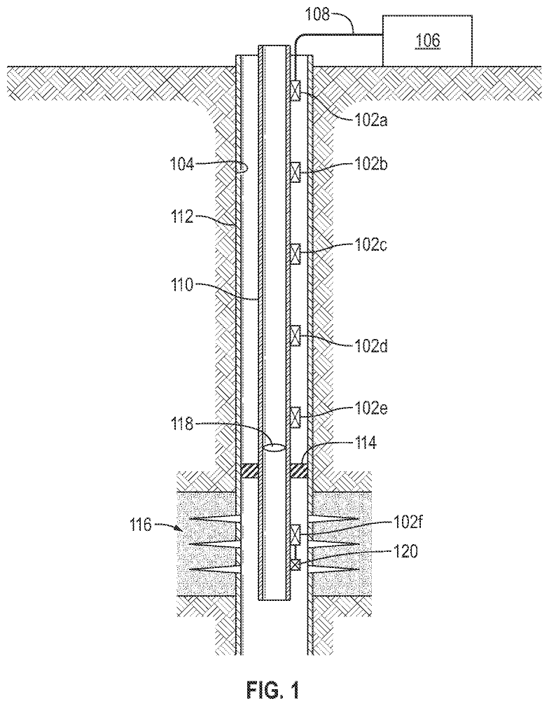

One type of wireless communications network that can be used to exchange messages between the surface and downhole equipment is an acoustic communication network. FIG. 1 shows a schematic view of an acoustic communication network that is deployed in a hydrocarbon well. It should be understood that the systems and techniques described herein are applicable throughout the life of the well, including during drilling, logging, drill stem testing, fracturing, stimulation, completion, cementing and production.

Referring to FIG. 1, a network of modems 102a-f is deployed in a wellbore 104 so that information can be exchanged between a surface control and telemetry system 106 and downhole equipment along both a downlink (from the surface to the downhole equipment) and an uplink (from the downhole equipment to the surface). The surface control and telemetry system 106 can include processing electronics, a memory or storage device and transceiver electronics to transmit and receive messages to and from the network of modems 102a-f via a wired connection 108. In various embodiments, the processing electronics can include a signal conditioner, filter, analog-to-digital converter, microcontroller, programmable gate array, etc. The memory or storage device can store telemetry data received from the downhole equipment so that it can be processed and analyzed later. Yet further, the memory or storage device can store instructions of software for execution by the processing electronics to generate messages to control and monitor performance of a downhole operation.

The modems 102a-f are acoustically coupled to an elastic medium, such as tubing 110, which can be a jointed pipe string, production tubing, or a drill string, that provides the acoustic communications path. It should be understood, however, that the elastic medium may be provided by other structures, such as a tubular casing 112 that is present in the wellbore 104, or by platform risers for subsea hydrocarbon well applications.

Because of the acoustic loss inherent to the elastic medium, communications in one hop from surface to downhole and vice versa generally are not feasible. Thus, a network of modems 102a-f is deployed to effectuate the downlink and uplink communications, where the modems 102a-f relay or repeat the messages that propagate along the transmission path or tubing 110.

In addition to the modems 102a-f, the installation shown in FIG. 1 includes a packer 114 positioned on the tubing 110 at a region of interest 116. Various pieces of downhole equipment for testing and the like are connected to the tubing 110, either above or below the packer 114, such as a test valve 118 above the packer 114 and a sensor 120 below the packer 114 as examples.

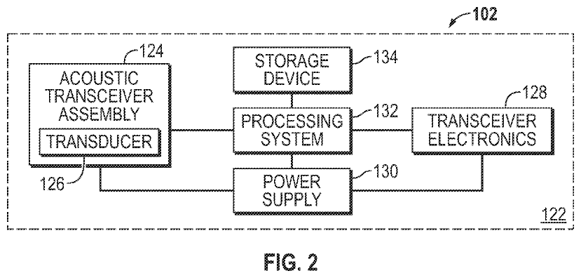

The modems 102a-f, which are part of the acoustic communications network, are made of electrical and mechanical components that provide the ability to transmit and receive acoustic signals that are exchanged between the surface and the downhole equipment. A schematic illustration of a modem 102 is illustrated in FIG. 2. Modem 102 includes a housing 122 that supports an acoustic transceiver assembly 124 that includes electronics and an acoustic sensor 126, such as a transducer that can be driven to create an acoustic signal in the tubing 110 and/or excited by an acoustic signal received from the tubing 110 to generate an electrical signal. The acoustic sensor 126 can include, for example, a piezoelectric stack, a magneto restrictive element, an accelerometer and/or an optical fiber or any other element or combination of elements that are suitable for converting an acoustic signal to an electrical signal and/or converting an electrical signal to an acoustic signal. The modem 102 also includes transceiver electronics 128 for transmitting and receiving electrical signals. Power can be provided by a power supply 130, such as a lithium battery, although other types of power supplies are possible, including supply of power from a source external to the modem 102.

The transceiver electronics 128 are arranged to receive an electrical signal from and transmit an electrical signal to the downhole equipment, such as the sensor 120 and the valve 118. The electrical signal can be in the form of a digital signal that is provided to a processing system 132, which can encode and modulate the signal, amplify the signal as needed, and transmit the encoded, modulated, and amplified signal to the transceiver assembly 124. The transceiver assembly 124 generates a corresponding acoustic signal for transmission via the tubing 110.

The transceiver assembly 124 of the modem 102 also is configured to receive an acoustic signal transmitted along the tubing 110, such as by another modem 102. The transceiver assembly 124 converts the acoustic signal into an electrical signal. The electrical signal then can be passed on to processing system 132, which demodulates and processes it for transmission as a digital signal to the downhole equipment or, in the case of modem 102a in FIG. 1, for transmission via the wired connection 108 to the surface control and telemetry system 106. Or, if the modem 102 is acting as a repeater in the acoustic network, the processing system 132 can encode, modulate and amplify the signal and return it to the transceiver assembly 124 for re-transmission to the next modems in the network. In embodiments, modems in the network can be bypassed, so that the “next” modems may not be the next physically adjacent modems. In various embodiments, the processing system 132 can include a signal conditioner, filter, analog-to-digital converter, demodulator, modulator, amplifier, encoder, decoder, microcontroller, programmable gate array, etc. The modem 102 also can include a memory or storage device 134 to store data received from the downhole equipment so that it can be transmitted or retrieved from the modem 102 later. Yet further, the memory or storage device 134 can store instructions of software for execution by the processing system 132 to perform the various modulation, demodulation, encoding, decoding, training, filtering and channel combining techniques described herein.

In the illustrative embodiments described herein, the messages exchanged between the surface and the downhole equipment can encompass control signals, polls for data, and telemetry signals such as tool status information and measurements provided by sensors. In general, the messages that are communicated are made up of a sequence of digital bits. To transmit the bits between components, the bits are transformed into a form suitable for acoustic transmission. That is the bits are transformed so that the information can be carried on an acoustic wave that propagates along the elastic structure that serves as the acoustic transmission medium. The technique for performing the transformation is generally referred to as modulation.

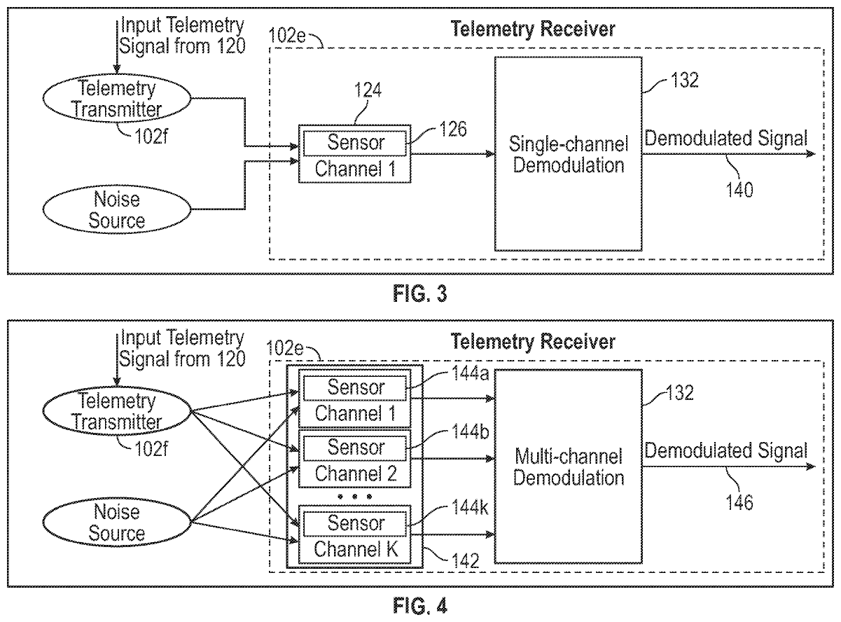

FIG. 3 is a schematic illustration of message communication in a wireless system in which messages exchanged between the surface and the downhole equipment are communicated using a single communication channel. While the following description will use telemetry signals as an example of a message that are transmitted acoustically, it should be understood that the systems and techniques described can also be applied to other types of messages, such as control signals, and other types of wireless communications.

In this example of a network with a single-channel receiver, acoustic modem 102e includes an acoustic transceiver assembly 124 with an acoustic sensor 126 that makes up the single receiver channel on which telemetry signals from downhole sensor 120 that have been acoustically transmitted by modem 102f are received. The acoustic telemetry signal is received by transceiver assembly 124 of modem 102e, converted to an electrical signal and then processed and demodulated by processing system 132 so that a demodulated telemetry signal 140 is generated as an output. Ideally, for successful communications, the demodulated telemetry signal 140 should be the equivalent of the original telemetry signal from downhole sensor 120. However, in practice, replication of the original signal is difficult to achieve because the acoustic transceiver assembly 124 of modem 102e generally will not receive a perfect or exact version of the acoustic signal transmitted by the modem 102f. For example, the acoustic signal can experience attenuation and reflections as it travels from modem 102f to the transceiver assembly 124 of modem 102e. And, the acoustic transceiver assembly 124 of modem 102e can receive acoustic noise components from various sources in addition to the transmitted acoustic signal. Examples of acoustic noise can include noise induced by downhole fluid flow, mechanical noise such as pipe banging, electrical noise, and echoes of the transmitted acoustic signal itself.

The processing system 132 of modem 102e must cope with the noise when it demodulates and processes the received telemetry signal. In some implementations, a model of the noise may exist (such as a model of the echoes) so that the processing by processing system 132 can use the model to reduce the noise from the telemetry signal. However, noise models often are not accurate or do not account for all noise sources and, thus, generally may not provide enough information for the processing system 132 to sufficiently reduce noise from the telemetry signal.

Accordingly, embodiments described herein provide a modem 102 with a multi-channel acoustic transceiver module assembly 142 that is configured with multiple receiver channels so that the processing system 132 can use spatial discrimination of the signal source to remove noise that does not propagate with the same properties as the signal source. For example, if the telemetry signal propagates upward using the longitudinal mode of the tubing or pipe string, and some noise also propagates upward using the same longitudinal mode, then the receiver will not be able to discriminate the telemetry signal. However, if the noise propagates in the opposite direction or with another propagation mode, then the receiver can apply the discrimination algorithm. The figure below displays the fundamental modes that exist in a pipe, where L (0,1) is the longitudinal mode, T (0,1) is the fundamental torsional mode, and F (1,1) is the flexural mode. The other modes are higher order modes that exist in the pipe string. Each of these modes has a specific slowness (inverse of velocity) vs frequency signature. If some noise propagates with F (1,1) mode and the telemetry signal propagates with L (0,1) mode, then the multi-channel receiver can process the received signal to discriminate the telemetry signal. Thus, in embodiments, the processing system 132 uses propagation properties to remove noise traveling on a different propagation mode or a different propagation direction than the mode on which propagation of the acoustic telemetry signal is expected.

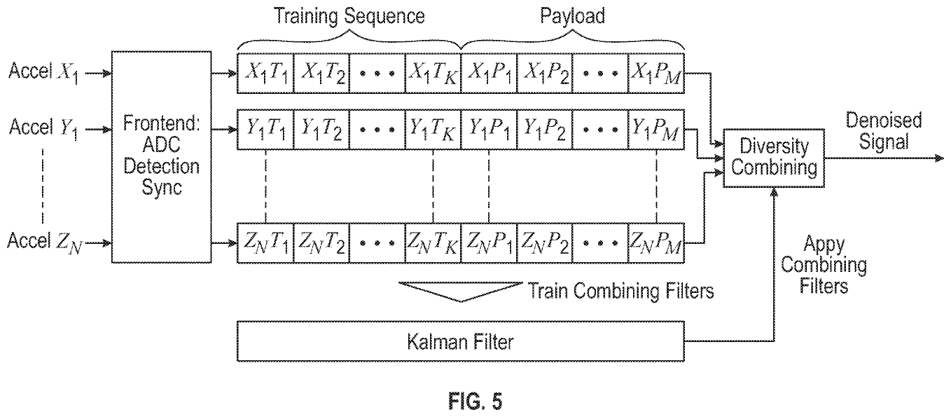

FIG. 4 schematically illustrates an example of communications in an acoustic communication network in which the modems 102a-f include a multi-channel acoustic transceiver assembly 142 according to embodiments described herein. As shown in FIG. 4, receiver channels 1, 2, . . . K feed the processing system 132. In embodiments, the receiver channels 1, 2, . . . K can be made up of the multiple axes of one or more multi-axis acoustic sensors 144, such as three-dimensional (3D) accelerometers, each of which can provide three separate channels. Multiple single axis sensors 144 that are arranged with different orientations also can be used to provide the multiple channels 1, 2, . . . K. Although three channels are shown in this example, a smaller or larger number of channels can be used based on the specific implementation in which the modem 102 is deployed. For example, two 3D accelerometers can act as six sensors to provide six channels.

In the embodiment of FIG. 4, each sensor 144a, b, . . . K receives both an image of the acoustic telemetry signal transmitted by the transmitter of modem 102f and an image of acoustic noise propagating in the environment. The acoustic signals received by sensors 144a, b, . . . K are converted into electrical signals and then combined by the processing system 132 in a manner that produces a demodulated output signal 146 that is substantially error free. More particularly, the propagation of the acoustic telemetry signal and the acoustic noise signal across the array of sensor channels 1, 2, . . . K carries certain characteristics that persist in time. For example, if the sensors 144 a, b, . . . K are spaced axially along the pipe or tubing 110 in the wellbore in a known manner and the telemetry signal travels with acoustic waves propagated using the longitudinal (or axial) mode of the tubing 110, then there is a [phase relationship between the acoustic signals received by each of the axial sensors 144 a, b, . . . K. If the acoustic noise signal propagates with another mode, such as the flexural mode of the tubing 110, then another type of relationship will dictate the relationship between the noise signal received by each of the sensors 144 a, b, . . . K. Consequently, using these relationships (which can be either pre-known or learned during operation of the communication network), the sensor channels 1, 2, . . . K can be combined in a manner that maximizes the accuracy of the reconstruction of the telemetry signal 146 that is output by the processing system 132.

The multi-channel processing can include any technique to combine the channels 1, 2, . . . K to increase the probability that the original telemetry signal can be accurately reconstructed. Such techniques can include, for example, combination techniques that use linear filtering, as well as techniques that use non-linear filtering. For example, equalization techniques can be used to cancel noise in a received signal. Equalization involves combining samples of the currently received signal with the previously demodulated signal to cancel echoes. In a multi-channel system, an equalization technique can be combined with multi-channel demodulation processing techniques to enhance the probability that the output telemetry signal is accurately reconstructed.

In embodiments, the multi-channel demodulation processing technique can be learned during operation of the communication network, which is referred to as “online training.” For example, the multiple channels can be combined in an equalizer. The equalizer is usually used to reduce the impact of signal echoes in a data stream, but the same formulation can be used for combining multiple channels. Instead of using one channel stream as the input of the equalizer, the samples of multiple channels are concatenated and then are fed to the equalizer. The properties of propagation are stable over time, so a training sequence can be used to learn the coefficients of the equalizer. Based on the training sequence, the equalizer learns how to combine the channels together in order to maximize the reconstruction of the training sequence. The same set of coefficients can be used on the data sequence, or it is also possible to continue adapting the coefficients as new data comes in. Online training offers the advantage that, when the channels are properly combined, substantial spatial diversity gains can be achieved. For example, with diversity, the acoustic sensors can measure a good signal and low noise at slightly different frequencies. Combining the best frequency bands across all acoustic sensors can improve the overall signal to noise ratio. A further advantage of online training is that actual characteristics associated with the propagation of telemetry signals and noise in the communication network are obtained, thereby minimizing the number of assumptions (and incorrect assumptions) that may otherwise be incorporated into a model of the expected characteristics of the telemetry and noise signals.

In embodiments, spatial diversity can be provided by multiple sensors that are spaced apart (either axially or radially) or that have different orientations (e.g., an accelerometer that can separately sense acoustic signals in each of three axes). In embodiments, in addition to spatial diversity, frequency redundancy can be implemented by transmitting duplicates of the telemetry signal on multiple non-overlapping frequency bands. Combining frequency redundancy with spatial diversity can further enhance the quality and accuracy of the output telemetry signal 146. For example, if two multi-axis sensors 144 (e.g., 3D accelerometers) are employed to sense signals that have been transmitted on three frequency channels, a total of eighteen channels are available for combining. It should be understood, however, that more or fewer channels can be made available or used.

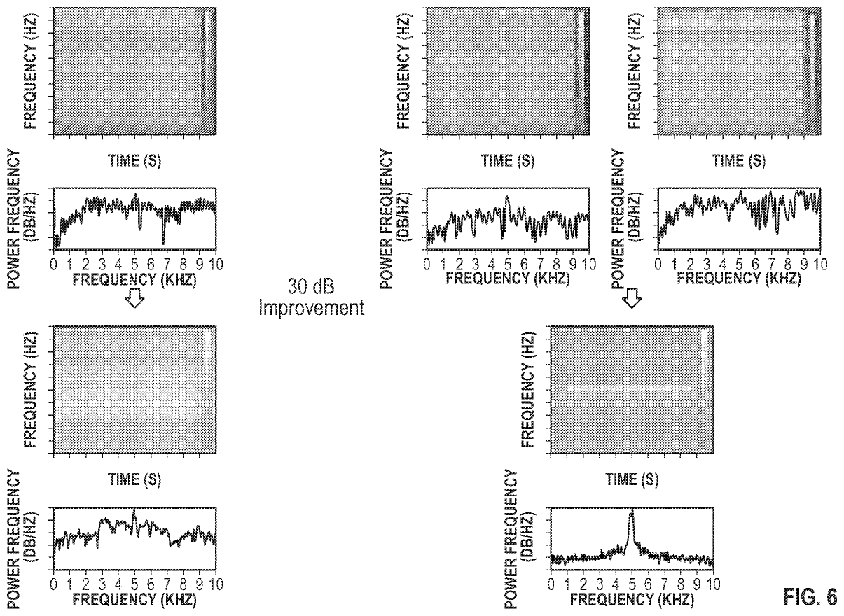

An example of an approach for combining multiple channels is illustrated in FIG. 5. In this example, data packets are transmitted by the source modem 102f and travel to the receiving modem 102e where the packets are converted to baseband symbols. In this example, the acoustic transceiver assembly 142 of the receiving modem 102e includes one or more triaxial sensors 144 providing channels X1, Y1 through ZN. Each data packet begins with a known data sequence that is used to train a combining filter of the processing system 132. In this example, the training sequence of data packets on channel X1 is X₁T₁, X₁T₂, . . . X₁T_{K}; the training sequence on channel Y1 is Y₁T₁, Y₁T₂, . . . Y₁T_{K}; and the training sequence on channel ZN is Z_{N}T₁, Z_{N}T₂, . . . Z_{N}T_{K}. Once the combining filter is trained, the same filtering coefficients are applied to the second part of the data packet (i.e., the payload “P”). The sequence of packets representing the payload thus are X₁P₁, X₁P₂, . . . X₁P_{M} on channel X₁; Y₁P₁, Y₁P₂, . . . Y₁P_{M} on channel Y₁; and Z_{N}P₁, Z_{N}P₂, . . . Z_{N}P_{M} on channel ZN. In the example shown, the processing system 132 uses a Kalman filter for the estimation of the training coefficient filter. However, any type of Bayesian filter can be used for training and channel combining, as well as other types of known or future algorithms for training and combining.

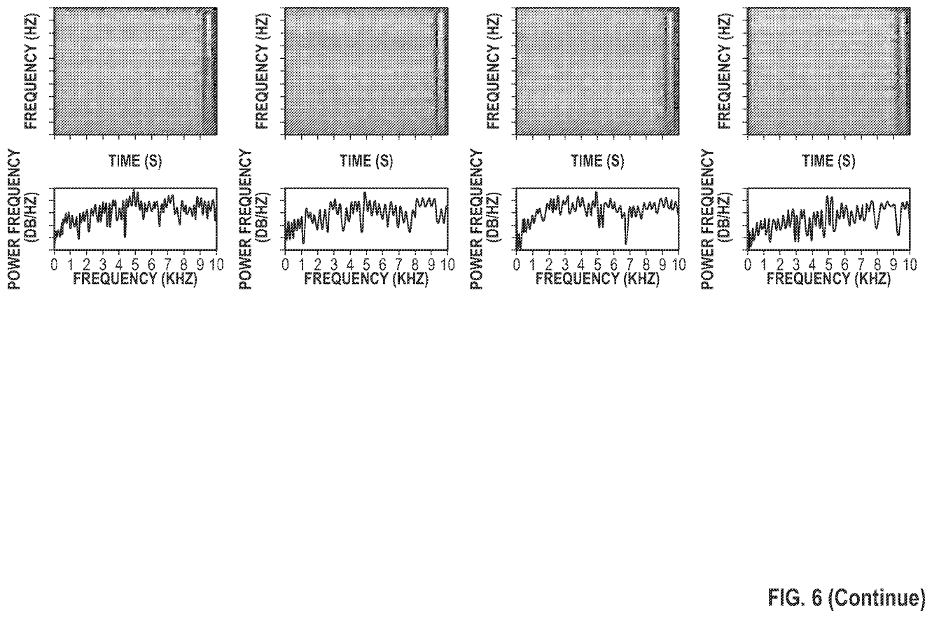

FIG. 6 illustrates the performance improvement relative to a single channel modem that can be obtained using a six-channel acoustic modem 102 that includes two 3D (or three-axis) accelerometers for spatial diversity and three frequency channels for frequency redundancy. The left side of FIG. 6 illustrates a typical performance of a signal channel modem, where the data was transmitted on a frequency channel of 5 kHz. The bottom graph on the left side shows the signal spectrum after processing, with power frequency (dB/Hz) on the y-axis and frequency (kHz) on the x-axis. As can be seen, the signal-to-noise ratio is very low so that the signal energy is barely visible above the noise floor.

In contrast, the right hand side of FIG. 6 shows the outcome of diversity/redundancy combining using six channels, which allows for recovery of more than 40 dB margin above the noise floor, representing approximately a 30 dB improvement relative to the single channel system.

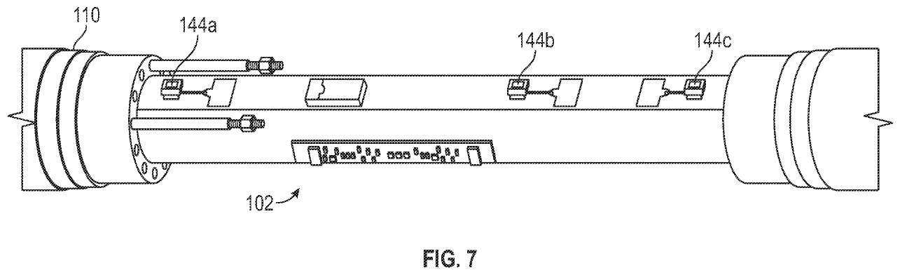

FIG. 7 is a perspective view of an example of a multi-channel modem 102 connected to tubing 110. The modem 102 includes three three-axis accelerometers 144a, 144b, 144c axially spaced along the tubing 110, thus providing nine channels to provide spatial diversity in the axial direction as well as in three differently oriented axes. In embodiments, one or more of sensors 144a, 144b and 144c also can be radially spaced along the tubing 110 relative to the other sensors 144 in order to further increase spatial diversity.

In the foregoing description, data and instructions for performing the various processes are stored in respective storage devices (such as, but not limited to, the storage device 134 associated with the modem 102 in FIG. 2) which are implemented as one or more non-transitory computer-readable or machine-readable storage media. The storage devices can include different forms of memory including semiconductor memory devices; magnetic disks such as fixed, floppy and removable disks; other magnetic media including tape; optical media such as compact disks (CDs) or digital video disks (DVDs); ROM, RAM, or other types of internal storage devices or external storage devices. The stored instructions can correspond to the channel combining schemes described herein and can be executed by a suitable processing device, such as, but not limited to, the processing system 132 in FIG. 2. The processing device can be implemented as a general purpose processor, a special purpose processor, a microprocessor, a microcontroller, and so forth, and can be one processor or multiple processors that execute instructions simultaneously, serially, or otherwise.

It should further be understood that the techniques described herein can be implemented in a variety of wireless communications systems, and that the physical layer of the communication is not limited to the acoustic telemetry system that has been described above.

Although the preceding description has been described herein with reference to a limited number of embodiments, it is not intended to be limited to the particulars disclosed herein; rather those skilled in the art, having the benefit of this disclosure, will appreciate numerous modifications and variations therefrom. It is intended that the appended claims cover such modifications and variations as fall within the true spirit and scope of the invention.

What is claimed is:

1. A method of communicating in an acoustic communication system that comprises a plurality of acoustic modems that exchange messages on an acoustic communications medium deployed in a borehole, comprising:
transmitting, by a first acoustic modem, an acoustic signal to transmit a message on the acoustic communication medium deployed in the borehole;
receiving, by a second acoustic modem, the acoustic signal on a plurality of receiver channels, wherein each receiver channel comprises an acoustic sensor, and wherein the plurality of receiver channels are deployed along the acoustic communications medium in a manner to provide spatial diversity; and
combining the acoustic signal received on the plurality of receiver channels to reconstruct the message, wherein combining comprises filtering noise from the acoustic signal.

2. The method as recited in claim 1, wherein the acoustic sensors comprise one or more three-dimensional accelerometers.

3. The method as recited in claim 1, wherein the acoustic sensors are deployed at spaced apart locations along the acoustic communications medium to provide spatial diversity.

4. The method as recited in claim 3, wherein the locations are spaced apart in an axial direction of the acoustic communications medium.

5. The method as recited in claim 3, wherein the locations are spaced apart in a radial direction of the acoustic communications medium.

6. The method as recited in claim 1, wherein the acoustic sensors are deployed with different axial orientations along the acoustic communications medium.

7. The method as recited in claim 1, wherein the transmitting comprises transmitting duplicate acoustic signals on a plurality of different frequencies.

8. The method as recited in claim 1, wherein combining comprises discriminating signals based on a propagation direction.

9. The method as recited in claim 1, wherein combining comprises filtering signals based on a propagation mode.

10. The method as recited in claim 1, wherein the first modem and the second modem comprise a transceiver.

11. A system for performing a downhole operation in a wellbore, the system comprising:
a control and telemetry system to control and monitor a downhole operation;
downhole equipment located in the wellbore to observe a parameter of interest associated with the downhole operation; and
first and second acoustic modems coupled to an acoustic transmission medium at respective locations extending between the control and telemetry system and the downhole equipment,
wherein the first acoustic modem transmits an acoustic signal carrying telemetry information from the downhole equipment, and wherein the second acoustic modem receives the acoustic signal on a plurality of receiver channels, wherein each receiver channel comprises an acoustic sensor deployed at a unique location and/or with a unique orientation along the acoustic transmission medium in order to provide spatial diversity.

12. The system as recited in claim 11, wherein the acoustic sensors comprise one or more three-dimensional accelerometers.

13. The system as recited in claim 11, wherein the acoustic sensors are deployed at spaced apart locations along the acoustic transmission medium to provide spatial diversity.

14. The system as recited in claim 13, wherein the spaced apart locations are spaced apart in an axial direction of the acoustic transmission medium.

15. The system as recited in claim 13, wherein the spaced apart locations are spaced apart in a radial direction of the acoustic transmission medium.

16. The system as recited in claim 11, wherein the acoustic sensors are deployed with different axial orientations along the acoustic transmission medium.

17. The system as recited in claim 11, wherein the first acoustic modem transmitting comprises transmitting duplicate acoustic signals on a plurality of different frequencies.

18. The system as recited in claim 11, wherein the system is configured to combine the acoustic signal received on the plurality of receiver channels to reconstruct the message, wherein combining comprises filtering noise from the acoustic signal and discriminating signals based on a propagation direction.

19. The system as recited in claim 18, wherein combining the acoustic signal received comprises filtering signals based on a propagation mode.

20. The system as recited in claim 11, wherein the first modem and the second modem comprise a transceiver.
